(19) United States
(12) Patent Application Publication
(10) Pub. No.: US 2025/0065548 A1
(43) Pub. Date: Feb. 27, 2025

(54) MOLD DEVICE AND METHOD FOR MANUFACTURING A CYLINDER

(71) Applicants: HYUNDAI MOTOR COMPANY, Seoul (KR); KIA CORPORATION, Seoul (KR); HANGUK MOLD CO.,LTD, Ulsan (KR)

(72) Inventors: Kyu Young Lee, Ulsan (KR); Suk Joo Hong, Suwon-si (KR); Jung Hwan Park, Ulsan (KR); Eui Hwan Son, Ulsan (KR); Min Woo Chu, Ulsan (KR); Byoung Jin Kwon, Ulsan (KR); Ji Hun Kim, Ulsan (KR)

(73) Assignees: HYUNDAI MOTOR COMPANY, Seoul (KR); KIA CORPORATION, Seoul (KR); HANGUK MOLD CO.,LTD, Ulsan (KR)

(21) Appl. No.: 18/526,755

(22) Filed: Dec. 1, 2023

(30) Foreign Application Priority Data
Aug. 21, 2023 (KR) 10-2023-0109248

(51) Int. Cl. B29C 45/04; B29C 45/26

(52) U.S. Cl. CPC B29C 45/0416; B29C 45/261; B29C 45/2606; B29C 45/4005; B29L 2031/7156

(57) ABSTRACT

A mold device includes: an outer mold part including a first outer mold, and a second outer mold that is moved toward the first outer mold to form a molding space with the first outer mold; and an inner mold part including an inner mold that is moved between a molding position disposed in the molding space of the outer mold part and an exit position deviating from the molding space. The inner mold is configured to mold a cylinder having a hollow part extending in a first direction between the inner mold part and the outer mold part when being located in the molding position. The inner mold is formed to correspond to the cylinder to form a space allowing introduction of a resin.

### CROSS-REFERENCE TO RELATED APPLICATION

This application claims the benefit of and priority to Korean Patent Application No. 10-2023-0109248, filed on Aug. 21, 2023, the entire contents of which are incorporated herein by reference.

### TECHNICAL FIELD

The present disclosure relates to a mold device and a method for manufacturing a cylinder.

### BACKGROUND

The statements in this section merely provide background information related to the present disclosure and may not constitute prior art.

Recently, as awareness of the crisis over the environment and depletion of oil resources has increased, research and development on electric vehicles, that are eco-friendly vehicles, has been highlighted. Electric vehicles include plug-in hybrid electric vehicle (PHEVs), battery electric vehicles (BEVs), and fuel cell electric vehicles (FCEVs).

A fuel cell electric vehicle (FCEV) includes a fuel cell stack that generates electricity using hydrogen, a hydrogen storage tank that stores hydrogen, and a battery pack that stores electrical energy generated by regenerative braking.

The FCEV essentially requires large-capacity hydrogen storage tanks to secure a long all-electric range (AER). To secure a long all-electric range (AER) of the FCEV, the hydrogen storage tank has a cylindrical shape that extends along a widthwise direction of the vehicle.

The hydrogen storage tank includes a material for sealing hydrogen in the hydrogen storage tank and may be molded by using a mold device. There may be a problem that a thickness of a hydrogen storage tank is not uniform.

### SUMMARY

The present disclosure has been made to solve the above-mentioned problems occurring in the prior art while advantages achieved by the prior art are maintained intact.

An aspect of the present disclosure provides a mold device and a method for manufacturing a cylinder, by which a thickness of a cylinder for a hydrogen storage tank may be formed to be uniform.

An aspect of the present disclosure also provides a mold device and a method for manufacturing a cylinder, by which degradation of a property of a cylinder for a hydrogen storage tank may be improved.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a mold device includes an outer mold part including a first outer mold, and a second outer mold that is configured to be moved toward the first outer mold to form a molding space with the first outer mold. The mold device further includes an inner mold part having an inner mold that is configured to be moved between a molding position disposed in the molding space of the outer mold part and an exit position deviating from the molding space. The inner mold is also configured to mold a cylinder having a hollow part extending in a first direction between the inner mold part and the outer mold part when being located in the molding position. The inner mold is also formed to correspond to the cylinder to form a space allowing introduction of a resin.

In one embodiment, the inner mold may include a first inner mold, and a second inner mold distinguished from the first inner mold. The first inner mold and the second inner mold may be configured to be moved toward each other.

In another embodiment, the outer mold part may include an inner peripheral surface formed to correspond to an outer surface of the cylinder. The outer mold part may also include a flange groove disposed at one end of the inner peripheral surface in the first direction, and formed in a concave shape in a second direction that is radially outward from the first direction from the inner peripheral surface.

The outer mold part may include a first flange surface that is configured to form the flange groove, and extend from the one end of the inner peripheral surface in the first direction toward the second direction. The outer mold part may also include a second flange surface extending from the first flange surface in the first direction, and a third flange surface extending from the second flange surface in an opposite direction to the second direction.

One end of the inner mold in the first direction may be disposed in the first direction of the flange groove when the inner mold is located in the molding position.

The inner mold part may further include a push rod connected to the inner mold, and an actuator connected to the push rod and configured to contract or extend the push rod.

The inner mold may include an insertion part configured such that the actuator is inserted into an interior of the inner mold when the inner mold is in the exit position.

The outer mold part may further include an inner surface formed to correspond to the cylinder, and an ejector member provided in an interior of the first outer mold. The ejector member is configured to separate the cylinder from the inner surface.

According to an aspect of the present disclosure, a method for manufacturing a cylinder includes moving a second outer mold toward a first outer mold to form a molding space between the first outer mold and the second outer mold. The method also includes moving an inner mold formed to correspond to a hollow cylinder extending in one direction between the first outer mold and the second outer mold to the molding space to mold the cylinder. Furthermore, the cylinder includes introducing a resin into the molding space.

The moving of the inner mold to the molding space may include moving the inner mold from an exit position deviating from the molding space to a molding position disposed in the molding space.

The inner mold may include a first inner mold, and a second inner mold distinguished from the first inner mold. The moving of the inner mold to the molding space may include moving the first inner mold and the second inner mold to the molding space such that the first inner mold and the second inner mold are moved toward each other.

The method may further include moving the second outer mold to separate the second outer mold from the first outer mold, and moving the inner mold in the molding space.

The moving of the inner mold in the molding space may include moving the inner mold from a molding position disposed in the molding space to an exit position deviating from the molding space.

The inner mold may include a first inner mold, and a second inner mold distinguished from the first inner mold. The moving of the inner mold in the molding space may include moving the first inner mold and the second inner mold such that the first inner mold and the second inner mold are separated from each other.

The method may further include moving an ejector member such that the cylinder is separated from the first outer mold.

### BRIEF DESCRIPTION OF THE DRAWINGS

The above and other objects, features, and advantages of the present disclosure should be more apparent from the following detailed description taken in conjunction with the accompanying drawings:

FIG. 1 is a side cross-sectional view of a mold device according to an embodiment of the present disclosure;

FIG. 2 is a cross-sectional view of a mold device according to an embodiment of the present disclosure;

FIG. 3 is a side cross-sectional view of a state, in which a second outer mold is moved toward a first outer mold, according to an embodiment of the present disclosure;

FIG. 4 is an enlarged view of portion “A” of FIG. 3;

FIG. 5 is a side cross-sectional view of a state, in which a first inner mold and a second inner mold are moved to a molding position, according to an embodiment of the present disclosure;

FIG. 6 is a cross-sectional view of a state, in which a first inner mold and a second inner mold are moved to a molding position, according to an embodiment of the present disclosure;

FIG. 7 is a side cross-sectional view of a state, in which a resin is introduced into a molding space, according to an embodiment of the present disclosure;

FIG. 8 is a side cross-sectional view of a state, in which a second outer mold is separated from a first outer mold, according to an embodiment of the present disclosure;

FIG. 9 is a side cross-sectional view of a state, in which a first inner mold and a second inner mold are moved from a molding position to an exit position;

FIG. 10 is a side cross-sectional view of a state, in which a cylinder is separated from a first outer mold due to an ejector member, according to an embodiment of the present disclosure;

FIG. 11 is a view illustrating an inner mold part according to another embodiment of the present disclosure; and

FIG. 12 is a flowchart illustrating a manufacturing method for molding a cylinder according to an embodiment of the present disclosure.

### DETAILED DESCRIPTION

Hereinafter, embodiments of the present disclosure are described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof is omitted.

Furthermore, in describing the components of the embodiments of the present disclosure, terms, such as first, second, “A,” “B,” (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

When a component, device, element, or the like of the present disclosure is described as having a purpose or performing an operation, function, or the like, the component, device, or element should be considered herein as being “configured to” meet that purpose or perform that operation or function.

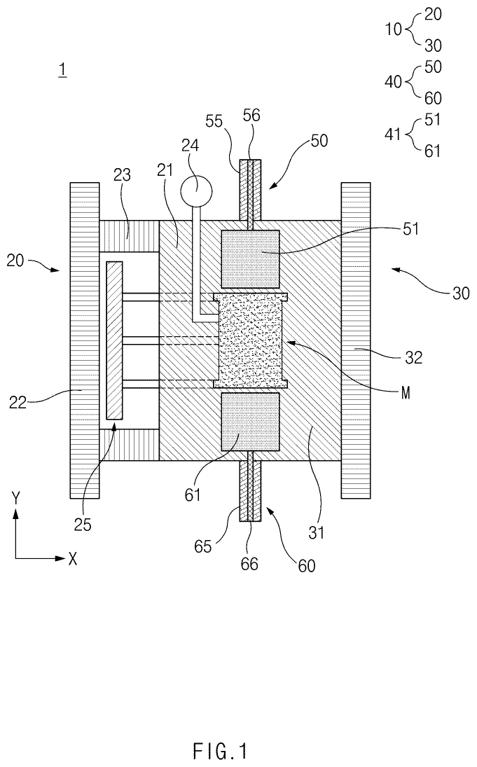

Hereinafter, embodiments of the present disclosure are described in detail with reference to FIGS. 1 to 12.

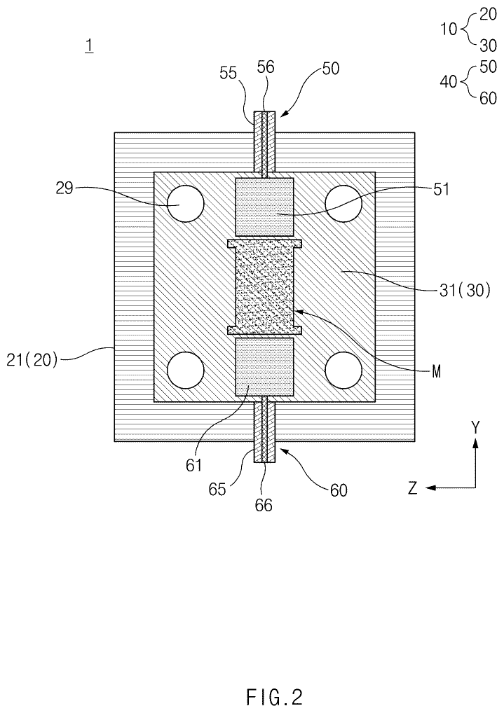

FIG. 1 is a side cross-sectional view of a mold device according to an embodiment of the present disclosure. FIG. 2 is a cross-sectional view of the mold device according to an embodiment of the present disclosure.

Referring to FIGS. 1 and 2, a mold device 1 may be a device for molding a cylinder “M” for a hydrogen storage tank. The cylinder “M” for a hydrogen storage tank may be formed in a cylindrical shape. The cylinder “M” for a hydrogen storage tank may extend such that a first direction (the “Y” direction) is a lengthwise direction thereof. Furthermore, the cylinder “M” for a hydrogen storage tank may be formed to have a hollow part (e.g., hollow space) that extends in the first direction to accommodate hydrogen in an interior thereof.

The cylinder “M” for a hydrogen storage tank may not have a dome part for providing a nozzle or the like at opposite sides thereof in the first direction. A separate cover member (not illustrated) may be coupled to the opposite sides of the cylinder “M” for a hydrogen storage tank in the first direction to seal the hydrogen.

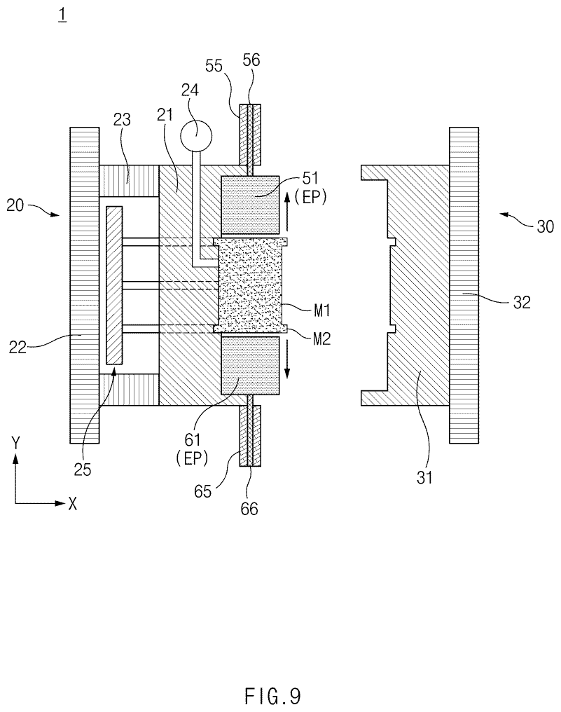

The cylinder “M” for a hydrogen storage tank may include a body part M1 (see FIG. 9) that is provided in a cylindrical shape in the first direction, and flange parts M2 that are provided at opposite side ends of the body part M1 in the first direction. Thicknesses of the flange parts M2 may be greater than a thickness of the body part M1 such that the separate cover member is coupled thereto.

Schemes for manufacturing the cylinder “M” for a hydrogen storage tank may include a scheme of injection-molding a resin in a mold to fill the resin. A hollow part is then formed by injecting air or water of a high pressure to a central portion thereof, which is not coagulated, in a state, in which an outer wall of the cylinder “M” for a hydrogen storage tank, which is formed of the resin, is coagulated by a specific thickness. However, according to the scheme, the thickness of the cylinder “M” for a hydrogen storage tank may not be constant, or the cylinder “M” for a hydrogen storage tank may contact water or the like whereby a property thereof may be changed.

In more detail, a material of the cylinder “M” for a hydrogen storage tank may be a reinforced PA6 material that enhances a hydrogen sealing performance unlike a general PA6 material formed of nylon or the like. The material may deteriorate the property when the hydrogen is leaked to an outside or contacts water or the like through a relatively thin part.

The cylinder “M” for a hydrogen storage tank according to an embodiment of the present disclosure may be manufactured through a scheme of molding it only with the mold device 1 unlike the above-described air injection scheme or water injection scheme.

However, the mold device 1 that molds the cylinder “M” for a hydrogen storage tank according to an embodiment of the present disclosure may be understood as not only a structure that molds only the cylinder “M” for a hydrogen storage tank but also that molds a cylinder “M” that has a hollow part in the first direction. Additionally, the cylinder “M” for a hydrogen storage tank “M” may be referred to as the cylinder “M” hereinafter.

The mold device 1 may include an outer mold part 10 that is formed to correspond to an outer surface of the cylinder “M”, and an inner mold part 40 that is formed to correspond to an inner surface of the cylinder “M”.

The outer mold part 10 may include a first outer mold part 20, a position of which is fixed, and a second outer mold part 30 that may be moved toward the first outer mold part 20.

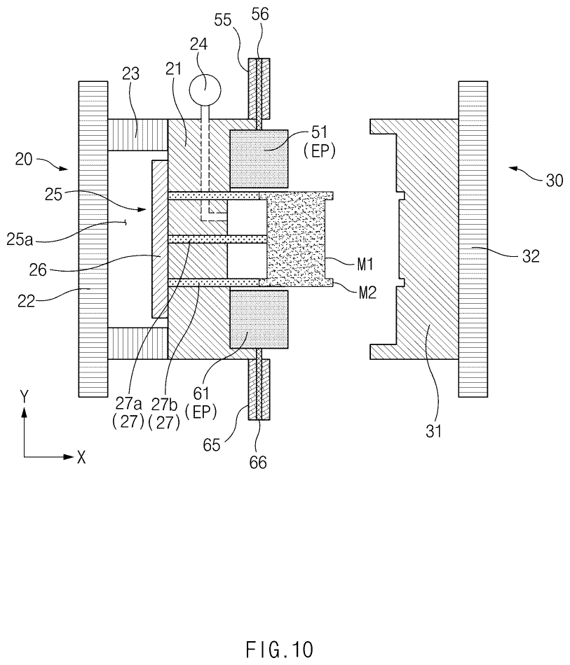

The first outer mold part 20 may include a first outer mold 21 that is configured to correspond to the outer surface of the cylinder “M”. The first outer mold part 20 may also include a first base plate 22 that is spaced apart from the first outer mold 21 in an opposite direction to the second outer mold part 30 and extends in the first direction. The first outer mold part 20 may also include a spacer 23 that connects the first outer mold 21 and the first base plate 22. The first outer mold 21 and the first base plate 22 may be spaced apart from each other due to the spacer 23, and an ejector accommodating part 25a (see FIG. 10) may be provided therebetween.

The first outer mold part 20 may include a resin accommodating part 24 that accommodates the PA6 material, of which a hydrogen sealing performance is reinforced.

The second outer mold part 30 may include a second outer mold 31 that is formed to correspond to the outer surface of the cylinder “M”. The second outer mold part 30 may also include a second base plate 32 that supports the second outer mold 31.

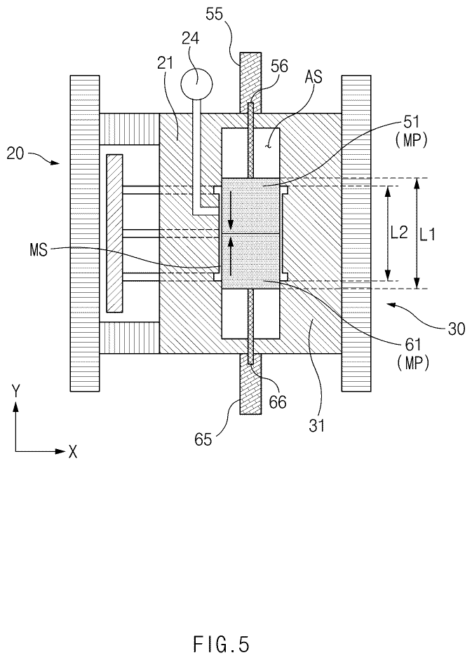

The second outer mold 31 may be moved toward the first outer mold 21 to form a molding space MS (see FIG. 5) and an accommodating space AS with the first outer mold 21. In other words, the molding space MS and the accommodating space AS may be communicated with each other and may be provided between the first outer mold 21 and the second outer mold 31.

Inner molds 51 and 61 that are configured to be moved in the molding space MS and the accommodating space AS may be provided between the first outer mold 21 and the second outer mold 31. The inner molds 51 and 61 may include the first inner mold 51 and the second inner mold 61. The inner molds 51 and 61 may move toward each other.

The inner mold part 40 may include an inner mold 41 having the first inner mold 51 and the second inner mold 61. In other words, the inner mold part 40 may include a first inner mold part 50 including the first inner mold 51, and a second inner mold part 60 including the second inner mold 61.

The first inner mold part 50 may include a first push rod 56 that moves the first inner mold 51 toward the second inner mold 61 or moves the first inner mold 51 to separate the first inner mold 51 from the second inner mold 61. The first push rod 56 may include one end that is connected to the first inner mold 51, and an opposite end that is accommodated in a first actuator 55 that is described below.

The first inner mold part 50 may include the first actuator 55 that contracts the first push rod 56 in the first direction or extends the first push rod 56 in an opposite direction (the −Y direction) to the first direction. The first actuator 55 may be provided with a hydraulic cylinder or the like to move the first push rod 56.

The second inner mold part 60 may include a second push rod 66 that moves the second inner mold 61 toward the first inner mold 51 or moves the second inner mold 61 to separate the second inner mold 61 from the first inner mold 51. The second push rod 66 may include one end that is connected to the second inner mold 61, and an opposite end that is accommodated in a second actuator 65 that is described below.

The second inner mold part 60 may include the second actuator 65 that contracts the second push rod 66 in the first direction or extends it in the opposite direction (the −Y direction) to the first direction. The second actuator 65 may be provided with a hydraulic cylinder or the like to move the second push rod 66.

The inner molds 51 and 61 may be formed to correspond to the cylinder “M” to form a space that allows introduction of a resin such that the cylinder “M” having a hollow part that extends in the first direction between the outer molds 21 and 31 is molded.

The outer mold part 10 may include a guide member 29 for guiding the coupling of the first outer mold 21 and the second outer mold 31 while adjusting a distance between the first outer mold 21 and the second outer mold 31. The guide member 29 may be coupled to each of the first outer mold 21 and the second outer mold 31 to connect the first outer mold 21 and the second outer mold 31.

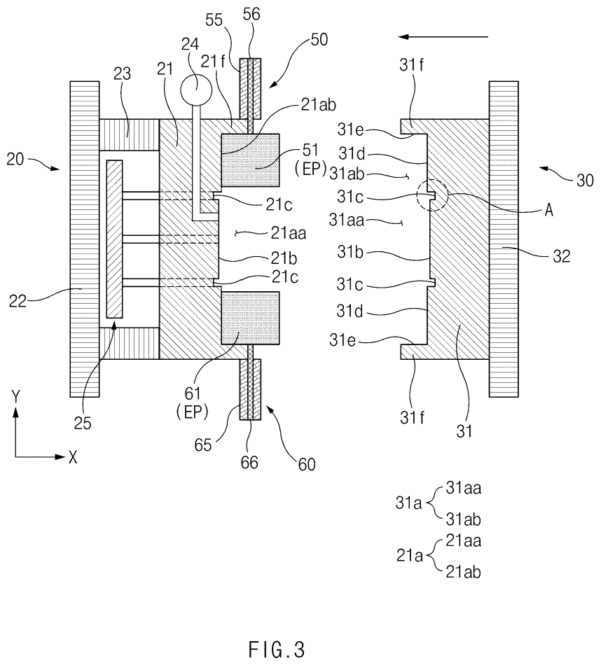

Hereinafter, a process of forming the cylinder “M” according to an embodiment of the present disclosure is described in detail with reference to FIGS. 3 to 10.

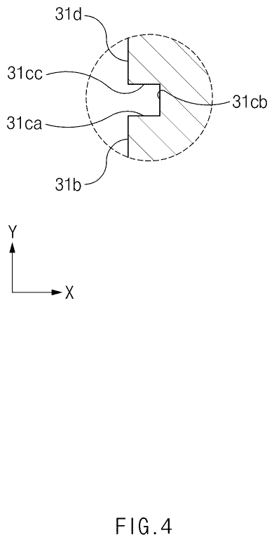

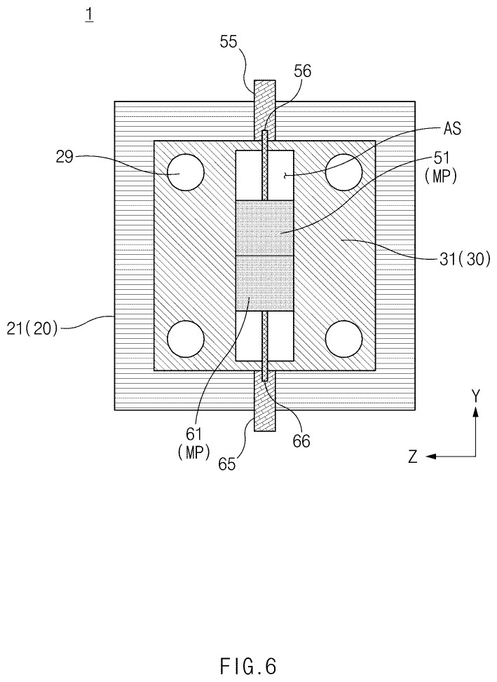

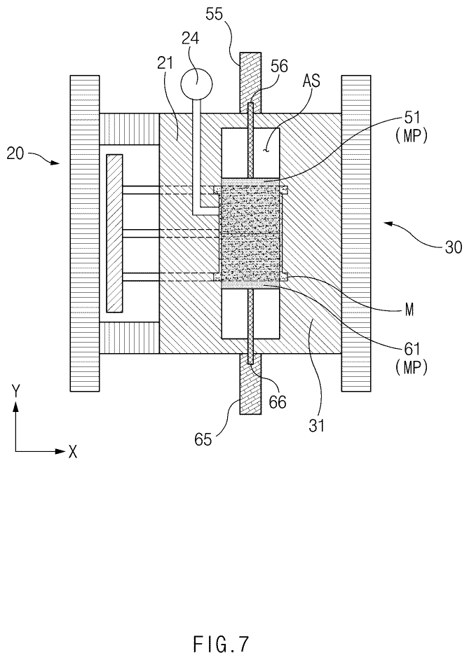

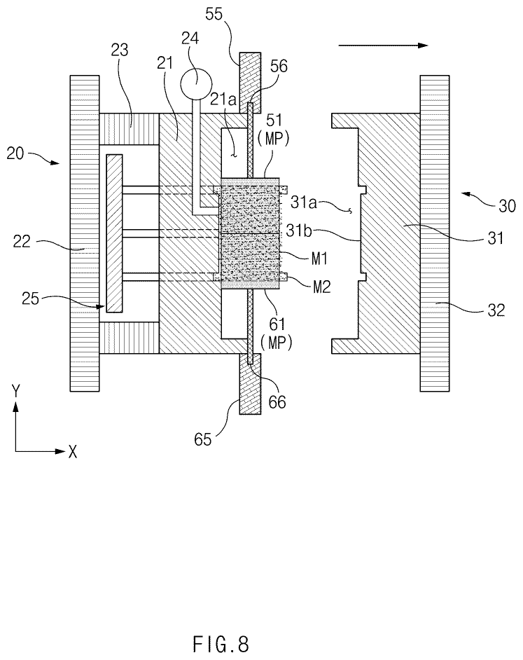

FIG. 3 is a side cross-sectional view of a state, in which the second outer mold is moved toward the first outer mold, according to an embodiment of the present disclosure. FIG. 4 is an enlarged view of portion “A” of FIG. 3. FIG. 5 is a side cross-sectional view of a state, in which the first inner mold and the second inner mold are moved to a molding position, according to an embodiment of the present disclosure. FIG. 6 is a cross-sectional view of a state, in which the first inner mold and the second inner mold are moved to the molding position, according to an embodiment of the present disclosure. FIG. 7 is a side cross-sectional view of a state, in which a resin is introduced into a molding space, according to an embodiment of the present disclosure. FIG. 8 is a side cross-sectional view of a state, in which the second outer mold is separated from the first outer mold, according to an embodiment of the present disclosure. FIG. 9 is a side cross-sectional view of a state, in which the first inner mold and the second inner mold are moved from the molding position to the exit position. FIG. 10 is a side cross-sectional view of a state, in which the cylinder is separated from the first outer mold due to the ejector member, according to an embodiment of the present disclosure.

Referring to FIGS. 3 to 10, the first outer mold 21 and the second outer mold 31 may be separated from each other. The first inner mold 51 and the second inner mold 61 are in a separated state, and the first push rod 56 and the second push rod 66 thereof are contracted. Positions of the first inner mold 51 and the second inner mold 61 may be exit positions EP that deviate from the molding space MS. The molding space MS may be provided between the first inner mold 51 and the second inner mold 61.

Furthermore, as is described below, the first inner mold 51 and the second inner mold 61 may be positioned at molding positions MP, in which they are disposed in the molding space MS to meet each other. In other words, the first inner mold 51 and the second inner mold 61 may be configured to be moved from the exit positions EP to the molding positions MP by the first push rod 56 and the second push rod 66, respectively.

The first outer mold 21 may form a first mold space 21a that is a portion of the molding space MS. When the first outer mold 21 is viewed from the second outer mold 31, the first mold space 21a may be a space that is formed by first cover parts 21f provided at opposite ends of the first outer mold 21 in the first direction and the opposite direction to the first direction.

The first mold space 21a may include a first molding part 21aa and a first accommodating part 21ab. The first molding part 21aa may be a space when the first inner mold 51 and the second inner mold 61 are positioned at the molding positions MP. The first accommodating part 21ab may be a space when the first inner mold 51 and the second inner mold 61 are positioned in the exit positions EP.

The first outer mold 21 may include a first inner peripheral surface 21b that is formed to correspond to the outer surface of the cylinder “M” and extends in the first direction (i.e., the Y direction). The first inner peripheral surface 21b may also extend a circumferential direction with respect to the first direction.

The first outer mold 21 may include first flange grooves 21c that are formed at one end and an opposite end of the first inner peripheral surface 21b in the first direction. A pair of first flange grooves 21c may be provided to have shapes that are concave toward a second direction (i.e., X direction) that is radially outward from the first direction, and may have a slot shape that extends along a portion of the circumferential surface of the inner peripheral surface 21b.

The second outer mold 31 may have a second mold space 31a that is the remaining part of the molding space MS. The second mold space 31a may be a space that is formed by cover parts 31f provided at opposite ends of the second outer mold 31 in the first direction and the opposite direction to the first direction when the second outer mold 31 is viewed from the first outer mold 21.

The second mold space 31a may include a second molding part 31aa and a second accommodating part 31ab. The second molding part 31aa may be a space when the first inner mold 51 and the second inner mold 61 are located in the molding positions MP, and the second accommodating part 31ab may be a space when the first inner mold 51 and the second inner mold 61 are positioned in the exit positions EP.

The first molding part 21aa and the second molding part 31aa may be communicated with each other to form the molding space MS. The first accommodating space 21ab and the second accommodating part 31ab may be communicated with each other to form the accommodating space AS.

The second outer mold 31 may include a second inner peripheral surface 31b that is formed to correspond to the outer surface of the cylinder “M” and extends along the first direction and a portion in the circumferential direction with respect to the first direction. Additionally, the second outer mold 31 includes second flange grooves 31c that are formed at one end and an opposite end of the second inner peripheral surface 31b in the first direction.

A pair of second flange grooves 31c may be provided to be positioned at the opposite ends of the second inner peripheral surface 31b to have shapes that are concave toward the second direction (i.e., the X direction) that is radially outward from the first direction. The pair of second flange grooves 31c may have slot shapes that extend along a portion of a circumferential surface of the second inner peripheral surface 31b.

The second outer mold 31 may include connecting surfaces 31d that are provided between the second flange grooves 31c and the second cover part 31f. The second outer mold 31 may also include support surfaces 31e that extend from the connecting surfaces 31d in the opposite direction to the second direction.

The connecting surfaces 31d may support outer peripheral surfaces of the first inner mold 51 and the second inner mold 61 when the first inner mold 51 and the second inner mold 61 are located in the exit positions EP.

The support surfaces 31e may be configured to support the first inner mold 51 and the second inner mold 61 when the first inner mold 51 and the second inner mold 61 are located in the exit positions EP. The support surfaces 31e may be disposed to be closer to the first inner mold 51 than the second inner peripheral surface 31b.

In other words, a distance (e.g., height) of the support surfaces 31e in the opposite direction to the second direction may be greater than that of the second inner peripheral surface 31b. This is because the support surfaces 31e may support the first inner mold 51 and the second inner mold 61 when the first inner mold 51 and the second inner mold 61 are in the exit positions EP. However, the second inner peripheral surface 31b has to be spaced apart from the first inner mold 51 and the second inner mold 61 such that the resin may be introduced when the first inner mold 51 and the second inner mold 61 are in the molding positions MP.

In more detail, the second outer mold 31 may include first flange surfaces 31ca that are configured to form the second flange grooves 31c and extend from opposite ends of the second inner peripheral surface 31b in the first direction, in the second direction. The second outer mold 31 may also include second flange surfaces 31cb that extend from the first flange surfaces 31ca in the first direction or the opposite direction to the first direction. Additionally, the second outer mold 31 may include third flange surfaces 31cc that extend from the second flange surfaces 31cb in the opposite direction to the second direction.

It may be understood that the structures of the connecting surfaces 31d, the support surfaces 31e, and the first to third flange surfaces 31ca, 31cb, and 31cc also are symmetrical to each other in the first outer mold 21 as well as the second outer mold 31.

When the second outer mold 31 meets the first outer mold 21 by the guide member 29, the first inner mold 51 and the second inner mold 61 that are in the exit positions EP in the accommodating space AS may be moved to the molding positions MP in the molding space MS. The first inner mold 51 and the second inner mold 61 may be moved in opposite directions, and may be moved in a direction that is perpendicular to a direction, in which the second outer mold 31 is moved.

In other words, the first actuator 55 and the second actuator 65 may extend the first push rod 56 and the second push rod 66, respectively, to move the first inner mold 51 and the second inner mold 61 such that the first inner mold 51 and the second inner mold 61 meet each other.

When the first inner mold 51 and the second inner mold 61 are positioned in the molding positions MP in the molding space MS, the resin in the resin accommodating part 24 may be introduced into the space that is provided between the outer molds 21 and 31 and the inner molds 51 and 61. The resin is introduced through the first outer mold 21.

Opposite ends of the inner molds 51 and 61 may be spaced apart from each other in the first direction farther than the pair of second flange grooves 31c. In other words, as illustrated in FIG. 5, when the inner molds 51 and 61 are located in the molding positions MP, a length L1 between the first inner mold 51 and the second inner mold 61 in the first direction may be greater than a length L2 between the pair of flange surfaces of the first flange grooves 21c and the third flange surfaces 31cc of the second flange grooves 31c in the first direction.

Because the structure is a structure, in which opposite ends of the inner molds 51 and 61 may be supported by the support surfaces 31e, the resin introduced toward the molding space MS may be prevented from being discharged to the accommodating space AS over the flange grooves 21c and 31c (i.e., first flange grooves 21c and second flange grooves 31c).

Furthermore, because the inner molds 51 and 61 are continuously pressed toward each other by the first push rod 56 and the second push rod 66, which are extended from the first actuator 55 and the second actuator 65, even when they are positioned in the molding positions MP, the resin introduced toward the molding space MS may be prevented from being discharged between the first inner mold 51 and the second inner mold 61.

According to the above-described structure, the resin is coagulated after a specific time period, and may have a shape of the cylinder “M” having the body part M1 and the flange parts M2.

After the specific time period, the second outer mold 31, as illustrated in FIG. 8, may be moved to be separated from the first outer mold 21.

Thereafter, as illustrated in FIG. 9, the first inner mold 51 and the second inner mold 61 may be moved to be separated from each other by the first push rod 56 and the second push rod 66.

The first inner mold 51 and the second inner mold 61 may be separated from the molding space MS by the first push rod 56 and the second push rod 66 and may be moved from the molding positions MP to the exit positions EP. The first inner mold 51 and the second inner mold 61 may be moved in opposite directions, and may also be moved in the direction that is perpendicular to the direction, in which the second outer mold 31 is moved.

When the first inner mold 51 and the second inner mold 61 reach the exit positions EP, the first inner mold 51 and the second inner mold 61 may be supported by the support surface and the connecting surface of the first outer mold 21 and the second outer mold 31. The first push rod 56 and the second push rod 66 may be contracted to the maximum level, respectively.

When the first inner mold 51 and the second inner mold 61 are moved to the exit positions EP and are accommodated in the accommodating space AS, the first inner mold 51 and the second inner mold 61 may be spaced apart from the cylinder “M” in the first direction.

In this state, when an ejector plate 26 of an ejector part 25 is moved toward the inner peripheral surface 21b of the first outer mold 21 in the ejector accommodating part 25a, an ejector member 27 that is connected to the ejector plate 26 and extends in the opposite direction to the second direction may push out the cylinder “M” such that the cylinder “M” is spaced apart (e.g., separated) from the inner surfaces 21b and inner flange surfaces of the flange grooves 21c of the first outer mold 21.

The inner surfaces 21b and 21c are surfaces that are formed to correspond to the cylinder “M”, and may be surfaces that include the first inner peripheral surface 21b and inner flange surfaces (e.g., second flange faces) of the first flange grooves 21c. Additionally, the inner surfaces 21b and 21c may be configurations that refer to the entire surface that faces the second outer mold 31 from the first molding part 21aa of the first outer mold 21.

The ejector member 27 may include a first ejector member 27a that is extracted from an interior of the first inner peripheral surface 21b, and a second ejector member 27b that is extracted from the first flange grooves 21c.

The first ejector member 27a may push out the body part M1 such that the body part M1 of the cylinder “M” is spaced apart from the first inner peripheral surface 21b.

According to the above-described structure, a thickness of the cylinder “M” may be formed to be constant according to the present disclosure, thereby improving a sealing performance of the cylinder “M”. The cylinder “M” includes the hollow part that extends in the first direction.

Furthermore, a property of the cylinder “M” prevents the cylinder “M” from being degraded when the cylinder “M” contacts water thereby enhancing the durability and the sealing property of the cylinder “M”.

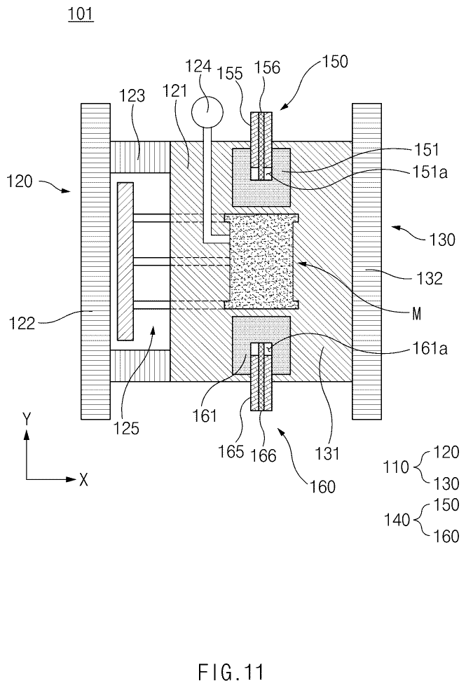

FIG. 11 is a view illustrating an inner mold part according to another embodiment of the present disclosure.

Referring to FIG. 11, according to an embodiment of the present disclosure, due to the configurations of the first actuator 55 and the second actuator 65 in the first direction of the mold device 1 (see FIG. 1), the space of the mold device 1 may be restricted or there may be a difficulty in installing the mold device 1.

To prevent this, according to another embodiment of the present disclosure, a mold device 101 may be formed such that a first actuator 155 and a second actuator 165 are inserted into a first inner mold 151 and a second inner mold 161.

In other words, when the first inner mold 151 and the second inner mold 161 are in the exit positions EP, a first push rod 156 and a second push rod 166 may be contracted by the first actuator 155 and the second actuator 165, respectively. The first inner mold 151 and the second inner mold 161 may be moved toward the first actuator 155 and the second actuator 165.

The first actuator 155 and the first push rod 156 may be structured to be inserted into a first insertion part 151a of the first inner mold 151. The second actuator 165 and the second push rod 166 may be structured to be inserted into a second insertion part 161a of the second inner mold 161.

The inner molds 151 and 161 may include the insertion parts 151a and 161a that are configured such that the actuators 155 and 165 are inserted into the inner molds 151 and 161, at sides thereof, to which the push rods 156 and 166 are coupled.

Due to the structure, the diameters of the actuators 155 and 165 may be smaller than the diameters of the inner molds 151 and 161.

According to the structure, according to the another embodiment of the present disclosure, an installation performance of the mold device 101 may be enhanced, and interferences with other devices that are adjacent to the mold device 101 may be prevented whereby safety and use performance may be enhanced.

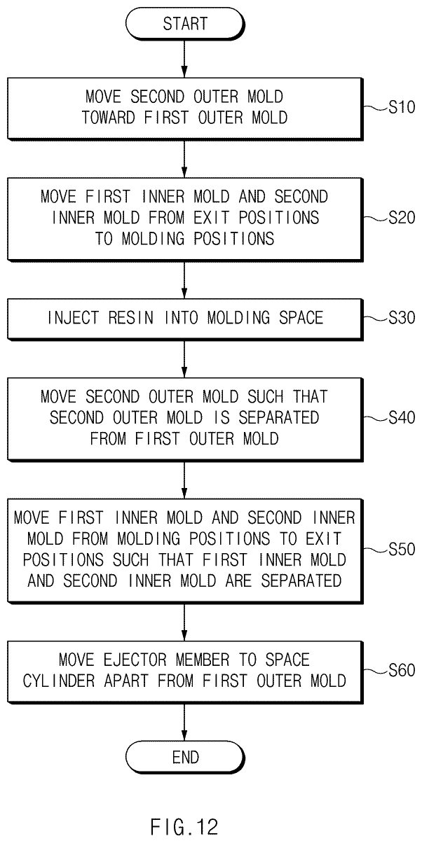

FIG. 12 is a flowchart illustrating a manufacturing method for molding a cylinder according to an embodiment of the present disclosure.

Referring to FIGS. 3 to 12, the manufacturing method for molding the cylinder “M” (see FIG. 1) is described.

The manufacturing method for manufacturing a cylinder may include an operation S10 of moving the second outer mold 31 toward the first outer mold 21 such that the molding space MS is formed between the first outer mold 21 and the second outer mold 31.

Thereafter, the manufacturing method for manufacturing the cylinder may include an operation S20 of moving the inner molds 51 and 61 from the exit positions EP that deviate from the molding space MS to the molding positions MP in the molding space MS. The inner molds 51 and 61 are formed to correspond to the cylinder “M” to mold the cylinder “M” having the hollow part that extends in the first direction between the first outer mold 21 and the second outer mold 31. The first inner mold 51 and the second inner mold 61 may be moved toward each other.

Thereafter, the manufacturing method for manufacturing the cylinder may include an operation S30 of injecting the resin into the molding space MS.

The manufacturing method for manufacturing the cylinder may include an operation S40 of moving the second outer mold 31 such that the second outer mold 31 is separated from the first outer mold 21 after a specific time period.

Thereafter, the manufacturing method for manufacturing the cylinder may include an operation S50 of moving the inner molds 51 and 61 from the molding positions MP in the molding space MS to the exit positions EP that deviate from the molding space MS. The first inner mold 51 and the second inner mold 61 may be moved to be separated from each other.

The manufacturing method for manufacturing the cylinder may include an operation S60 of moving the ejector member 27 such that the cylinder “M” is spaced apart from the first outer mold 21.

When the cylinder “M” is molded according to the sequence, as described above, unlike the water injection scheme or the air injection scheme, because the cylinder “M” is molded by the inner molds 51 and 61 having a physical form, a thickness of the cylinder “M” may be made to be uniform whereby a sealing performance of the hydrogen may be enhanced.

In addition, because the resin may be a reinforced PA6 material, a hydrogen sealing performance of a property degradation problem that occurs when the material contacts water may be prevented thereby enhancing the hydrogen sealing performance of the cylinder “M”.

According to the present technology, because the thickness of the cylinder for a hydrogen storage tank may be formed to be uniform, a hydrogen sealing performance of the cylinder for a hydrogen storage tank may be enhanced.

Furthermore, according to the present technology, degradation of a property of the cylinder for a hydrogen storage tank may be improved, and thus, durability may be enhanced.

In addition, according to the present technology, an installation performance of the mold device of the cylinder for a hydrogen storage tank may be enhanced.

In addition, various effects directly or indirectly recognized through the specification may be provided.

The above description is a description of the technical spirits of the present disclosure, and a person having ordinary skill in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A mold device comprising:
an outer mold part including a first outer mold, and a second outer mold configured to be moved toward the first outer mold to form a molding space with the first outer mold; and
an inner mold part including an inner mold configured to be moved between a molding position disposed in the molding space of the outer mold part and an exit position deviating from the molding space, the inner mold part configured to mold a cylinder having a hollow part extending in a first direction between the inner mold and the outer mold part when the outer mold part is located in the molding position,
wherein the inner mold is formed to correspond to the cylinder to form a space allowing introduction of a resin.

2. The mold device of claim 1, wherein the inner mold includes:
a first inner mold; and
a second inner mold distinguished from the first inner mold, and
wherein the first inner mold and the second inner mold are configured to be moved toward each other.

3. The mold device of claim 1, wherein the outer mold part further includes:
an inner peripheral surface formed to correspond to an outer surface of the cylinder; and
a flange groove disposed at one end of the inner peripheral surface in the first direction, and formed in a concave shape in a second direction that is radially outward from the first direction from the inner peripheral surface.

4. The mold device of claim 3, wherein the outer mold part further includes:
a first flange surface configured to form the flange groove, and extending from the one end of the inner peripheral surface in the first direction toward the second direction;
a second flange surface extending from the first flange surface in the first direction; and
a third flange surface extending from the second flange surface in an opposite direction to the second direction.

5. The mold device of claim 3, wherein one end of the inner mold in the first direction is disposed in the first direction of the flange groove when the inner mold is located in the molding position.

6. The mold device of claim 1, wherein the inner mold part further includes:
a push rod connected to the inner mold; and
an actuator connected to the push rod and configured to contract or extend the push rod.

7. The mold device of claim 6, wherein the inner mold includes an insertion part configured such that the actuator is inserted into an interior of the inner mold when the inner mold is in the exit position.

8. The mold device of claim 1, wherein the outer mold part further includes:
an inner surface formed to correspond to the cylinder; and
an ejector member provided in an interior of the first outer mold, and configured to separate the cylinder from the inner surface.

9. A method for manufacturing a cylinder, the method comprising:
moving a second outer mold toward a first outer mold to form a molding space between the first outer mold and the second outer mold;
moving an inner mold formed to correspond to a hollow cylinder extending in one direction between the first outer mold and the second outer mold to the molding space to mold the cylinder; and
introducing a resin into the molding space.

10. The method of claim 9, wherein the moving of the inner mold to the molding space includes:
moving the inner mold from an exit position deviating from the molding space to a molding position disposed in the molding space.

11. The method of claim 9, wherein the inner mold includes a first inner mold, and a second inner mold distinguished from the first inner mold, and
wherein the moving of the inner mold to the molding space includes:
moving the first inner mold and the second inner mold to the molding space such that the first inner mold and the second inner mold are moved toward each other.

12. The method of claim 9, further comprising:
moving the second outer mold to separate the second outer mold from the first outer mold; and
moving the inner mold in the molding space.

13. The method of claim 12, wherein the moving of the inner mold in the molding space includes:
moving the inner mold from a molding position disposed in the molding space to an exit position deviating from the molding space.

14. The method of claim 12, wherein
the inner mold includes:
a first inner mold; and
a second inner mold distinguished from the first inner mold, and
wherein the moving of the inner mold in the molding space includes:
moving the first inner mold and the second inner mold such that the first inner mold and the second inner mold are separated from each other.

15. The method of claim 12, further comprising:
moving an ejector member such that the cylinder is separated from the first outer mold.
